(19) United States
(12) Patent Application Publication
(10) Pub. No.: US 2025/0354963 A1
(43) Pub. Date: Nov. 20, 2025

(54) MATERIAL ESTIMATION METHOD, MATERIAL ESTIMATION SYSTEM, MATERIAL ESTIMATION DEVICE, AND RECORDING MEDIUM

(71) Applicant: Panasonic Intellectual Property Management Co., Ltd., Osaka (JP)

(72) Inventors: Risako TANIGAWA, Kanagawa (JP); Toshiyuki MATSUMURA, Osaka (JP); Mariko YAMADA, Hyogo (JP); Tomokazu ISHIKAWA, Osaka (JP)

(21) Appl. No.: 19/289,384

(22) Filed: Aug. 4, 2025

Related U.S. Application Data
(63) Continuation of application No. PCT/JP2024/002095, filed on Jan. 24, 2024.

(30) Foreign Application Priority Data
Feb. 10, 2023 (JP) 2023-019271

(51) Int. Cl. G01N 29/46; G01B 15/08; G01N 29/04

(52) U.S. Cl. CPC G01N 29/46; G01B 15/08; G01N 29/04; G01N 2291/023

(57) ABSTRACT

A material estimation method includes emitting an emission sound toward an estimation target of which a material is to be estimated; obtaining a reflected sound of the emission sound reflected by the estimation target; extracting an acoustic feature of the estimation target based on the reflected sound, the acoustic feature including information pertaining to a reverberation time of an impulse response; and estimating the material of the estimation target based on the acoustic feature of the estimation target.

### CROSS REFERENCE TO RELATED APPLICATIONS

This is a continuation application of PCT International Application No. PCT/JP2024/002095 filed on Jan. 24, 2024, designating the United States of America, which is based on and claims priority of Japanese Patent Application No. 2023-019271 filed on Feb. 10, 2023. The entire disclosures of the above-identified applications, including the specifications, drawings and claims are reflected herein by reference in their entirety.

### FIELD

The present disclosure relates to a material estimation method, a material estimation system, a material estimation device, and a recording medium for estimating a material.

### BACKGROUND

Conventionally, there is known a device that identifies a substance with the use of an ultrasonic wave. As one example of this type of device, Patent Literature (PTL) 1 discloses a substance identification device that identifies the hardness of a substance based on a change in the frequency characteristics of a reflected ultrasonic wave.

### CITATION LIST

### Patent Literature

PTL 1: Japanese Unexamined Patent Application Publication No. 2021-131272

### SUMMARY

### Technical Problem

The present disclosure provides a material estimation method and so forth that make it possible to estimate the material of an estimation target based on information pertaining to a sound from the estimation target.

### Solution to Problem

A material estimation method according to one aspect of the present disclosure is a material estimation method to be executed by a computer, and the material estimation method includes: emitting an emission sound toward an estimation target of which a material is to be estimated; obtaining a reflected sound of the emission sound reflected by the estimation target; extracting an acoustic feature of the estimation target based on the reflected sound, the acoustic feature including information pertaining to a reverberation time of an impulse response; and estimating the material of the estimation target based on the acoustic feature of the estimation target.

A material estimation system according to one aspect of the present disclosure includes: a sound emitter that emits an emission sound toward an estimation target of which a material is to be estimated; a sound receiver that obtains a reflected sound of the emission sound reflected by the estimation target; an extractor that extracts an acoustic feature of the estimation target based on the reflected sound, the acoustic feature including information pertaining to a reverberation time of an impulse response; and an estimator that estimates the material of the estimation target based on the acoustic feature of the estimation target.

A material estimation device according to one aspect of the present disclosure includes: an extractor that, based on a reflected sound of an emission sound emitted toward an estimation target of which a material is to be estimated and reflected by the estimation target, extracts an acoustic feature of the estimation target, the acoustic feature including information pertaining to a reverberation time of an impulse response; and an estimator that estimates the material of the estimation target based on the acoustic feature of the estimation target.

A recording medium according to one aspect of the present disclosure is a non-transitory computer-readable recording medium having recorded thereon a program for causing a computer to execute the material estimation method above.

It is to be noted that general or specific aspects of the present disclosure may be implemented in the form of a system, a method, an integrated circuit, a computer program, or a computer readable recording medium, such as a compact disc-read only memory (CD-ROM), or through any desired combinations of a system, a method, an integrated circuit, a computer program, and a recording medium.

### Advantageous Effects

The present disclosure makes it possible to estimate the material of an estimation target based on information pertaining to a sound from the estimation target.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a drawing showing a material estimation system according to Embodiment 1.

FIG. 2 is a block diagram showing a functional configuration of the material estimation system according to Embodiment 1 as well as functional configurations of a detection device, a material estimation device, and so forth included in the material estimation system.

FIG. 3 is a drawing showing the detection device included in the material estimation system.

FIG. 4 is a drawing showing one example of an impulse response obtained from a reflected sound or the like reflected by an estimation target.

FIG. 5 is a drawing showing of a reverberation curve of an impulse response.

FIG. 6 is a diagram showing one example of a frequency characteristic of a received sound signal that is based on a reflected sound.

FIG. 7 is a drawing showing one example of feature values of a plurality of materials stored in advance in the material estimation device.

FIG. 8 is a drawing showing one example of a screen displayed on a user interface device.

FIG. 9 is a drawing showing another example of a screen displayed on the user interface device.

FIG. 10 is a drawing showing yet another example of a screen displayed on the user interface device.

FIG. 11 is a drawing showing one example of a screen displayed on the material estimation device.

FIG. 12 is a flowchart showing a material estimation method according to Embodiment 1.

FIG. 13 is a flowchart showing a material estimation method according to Variation 1 of Embodiment 1.

FIG. 14 is a drawing showing one example of a screen displayed on an information terminal according to Variation 1 of Embodiment 1.

FIG. 15 is a block diagram showing a functional configuration of a material estimation system according to Variation 2 of Embodiment 1.

FIG. 16 is a drawing showing one example of feature values of a plurality of materials stored in advance in a material estimation device according to Variation 2 of Embodiment 1.

FIG. 17 is a drawing showing a material estimation system according to Variation 3 of Embodiment 1.

FIG. 18 is a drawing showing a learning model and so forth used in a material estimation device according to Variation 3 of Embodiment 1.

FIG. 19 is a drawing showing training data to be used in training a learning model.

FIG. 20 is a block diagram showing a functional configuration of a material estimation system according to Embodiment 2.

### DESCRIPTION OF EMBODIMENTS

In order to reproduce a more realistic environment in a virtual space, it is important to enhance the immersive quality of sound. What is needed to enhance the immersive quality of sound is to simulate the sound propagation of real space in the virtual space. One of the elements needed to simulate how a sound propagates is the reflection characteristics of that sound, but different materials constituting the real space exhibit different sound reflection characteristics. Therefore, information pertaining to the materials of objects constituting the real space and information pertaining to the sound reflection characteristics of these materials are obtained, and the obtained items of information are reflected in the data of the virtual space. The material estimation method and so forth according to the present disclosure can be used, for example, in obtaining information pertaining to the materials of objects constituting real space.

A material estimation method according to Example 1 is a material estimation method to be executed by a computer, and the material estimation method includes emitting an emission sound toward an estimation target of which a material is to be estimated; obtaining a reflected sound of the emission sound reflected by the estimation target; extracting an acoustic feature of the estimation target based on the reflected sound, the acoustic feature including information pertaining to a reverberation time of an impulse response; and estimating the material of the estimation target based on the acoustic feature of the estimation target.

This material estimation method makes it possible to estimate the material of the estimation target based on the information pertaining to the sound from the estimation target.

A material estimation method according to Example 2 is the material estimation method according to Example 1 in which the sound is an ultrasonic wave.

This material estimation method makes it possible to estimate the material of the estimation target based on the feature value pertaining to the ultrasonic wave from the estimation target.

A material estimation method according to Example 3 is the material estimation method according to Example 1 or Example 2 in which the impulse response is derived by applying inverse Fourier transform to a transfer function in which a denominator is a signal obtained by applying Fourier transform to a sound emission signal for emitting the emission sound and a numerator is a signal obtained by applying Fourier transform to a received sound signal that is based on the reflected sound.

This material estimation method makes it possible to estimate the material of the estimation target based on the information pertaining to the sound from the estimation target that includes the information pertaining to the reverberation time of the impulse response.

A material estimation method according to Example 4 is the material estimation method according to any one of Example 1 to Example 3 in which the acoustic feature of the estimation target further includes a frequency characteristic of a received sound signal that is based on the reflected sound.

This material estimation method makes it possible to estimate the material of the estimation target based on the acoustic feature of the estimation target that includes the frequency characteristic of the received sound signal that is based on the reflected sound.

A material estimation method according to Example 5 is the material estimation method according to Example 4 in which the frequency characteristic is derived based on a transfer function in which a denominator is a signal obtained by applying Fourier transform to a sound emission signal for emitting the emission sound and a numerator is a signal obtained by applying Fourier transform to the received sound signal.

This material estimation method makes it possible to estimate the material of the estimation target based on the information pertaining to the sound from the estimation target that includes the frequency characteristic derived based on the transfer function described above.

A material estimation method according to Example 6 is the material estimation method according to any one of Example 1 to Example 5 in which the material of the estimation target is estimated by comparing the acoustic feature of the estimation target with feature values of materials stored.

In this manner, the material of the estimation target can be estimated based, for example, on the degree of similarity between two feature values by comparing the acoustic feature of the estimation target with a stored feature value of a material. This material estimation method can increase the accuracy in estimating the material of the estimation target.

A material estimation method according to Example 7 is the material estimation method according to any one of Example 1 to Example 3 in which the acoustic feature of the estimation target includes a spectrogram that includes information pertaining to the reverberation time, and the material of the estimation target is estimated by inputting the spectrogram to a learning model.

This material estimation method makes it possible to estimate the material of the estimation target by inputting the spectrogram described above into the learning model.

A material estimation method according to Example 8 is the material estimation method according to Example 7 in which the learning model is a model trained by machine learning with use of the spectrogram and information pertaining to the material.

This material estimation method makes it possible to estimate the material of the estimation target with the use of the model trained by machine learning.

A material estimation method according to Example 9 is the material estimation method according to any one of Example 1 to Example 6, and further includes obtaining degrees of similarity between the acoustic feature of the estimation target and feature values of materials stored; and determining, among the materials stored, a material having a degree of similarity higher than or equal to a predetermined value to be the material of the estimation target.

In this manner, determining that the material with the degree of similarity higher than or equal to the predetermined value is the material of the estimation target can increase the accuracy in estimating the material of the estimation target.

A material estimation method according to Example 10 is the material estimation method according to any one of Example 1 to Example 6, and further includes obtaining degrees of similarity between the acoustic feature of the estimation target and feature values of materials stored; and when the degrees of similarity are lower than a predetermined value, outputting a signal to change a distance between the estimation target and a device that obtains the reflected sound.

In this manner, outputting a signal instructing to change the distance between the estimation target and the device that obtains the reflected sound makes it possible to, for example, obtain again a acoustic feature of the estimation target, and thus the accuracy in estimating the material of the estimation target can be increased.

A material estimation method according to Example 11 is the material estimation method according to any one of Example 1 to Example 6 in which the acoustic feature of the estimation target further includes information about the sound related to surface unevenness of the estimation target.

In this manner, having the acoustic feature further include the information about the sound related to the unevenness of the surface of the estimation target makes it possible to increase the amount of information that can be used to estimate the estimation target, and thus the accuracy in estimating the material of the estimation target can be increased.

A material estimation system according to Example 12 includes a sound emitter that emits an emission sound toward an estimation target of which a material is to be estimated; a sound receiver that obtains a reflected sound of the emission sound reflected by the estimation target; an extractor that extracts an acoustic feature of the estimation target based on the reflected sound, the acoustic feature including information pertaining to a reverberation time of an impulse response; and an estimator that estimates the material of the estimation target based on the acoustic feature of the estimation target.

This configuration makes it possible to estimate the material of the estimation target based on the information pertaining to the sound from the estimation target.

A material estimation device according to Example 13 includes an extractor that, based on a reflected sound of an emission sound emitted toward an estimation target of which a material is to be estimated and reflected by the estimation target, extracts an acoustic feature of the estimation target, the acoustic feature including information pertaining to a reverberation time of an impulse response; and an estimator that estimates the material of the estimation target based on the acoustic feature of the estimation target.

This configuration makes it possible to estimate the material of the estimation target based on the information pertaining to the sound from the estimation target.

A recording medium according to Example 14 is a non-transitory computer-readable recording medium having recorded thereon a program for causing a computer to execute the material estimation method according to any one of Example 1 to Example 11.

This recording medium can provide a material estimation method that estimates the material of the estimation target.

Hereinafter, a material estimation method, a material estimation system, a material estimation device, and so forth according to one aspect of the present disclosure will be described in concrete terms with reference to the accompanying drawings.

It is to be noted that the embodiments described hereinafter all illustrate specific examples of the present disclosure. The numerical values, the shapes, the materials, the constituent elements, the arrangement positions and the connection modes of the constituent elements, the steps, the order of the steps, and so forth illustrated according to the following embodiments are examples and are not intended to limit the present disclosure. Among the constituent elements according to the following exemplary embodiments, any constituent elements that are not cited in the independent claims expressing the broadest concept are to be construed as optional constituent elements.

### Embodiment 1

### Overall Configuration of Material Estimation System

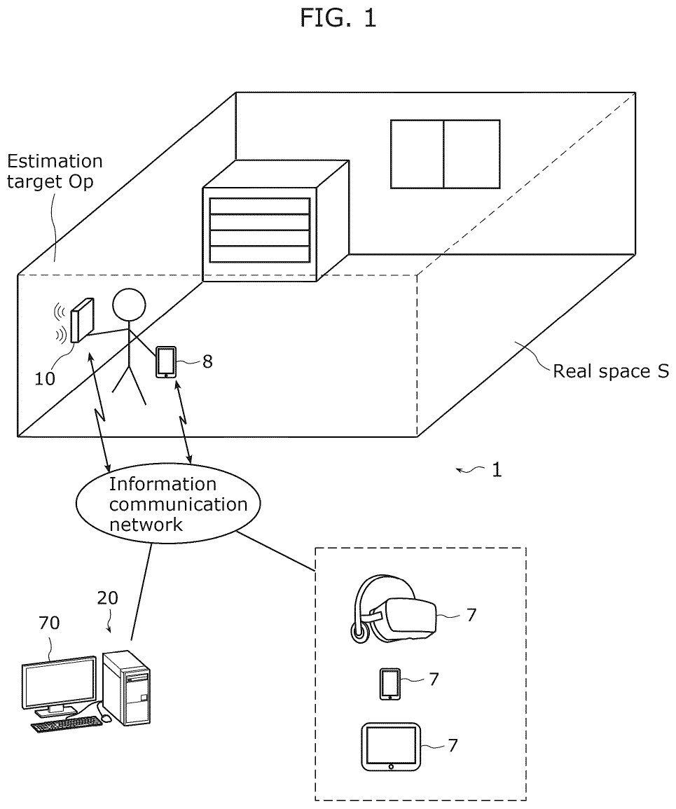

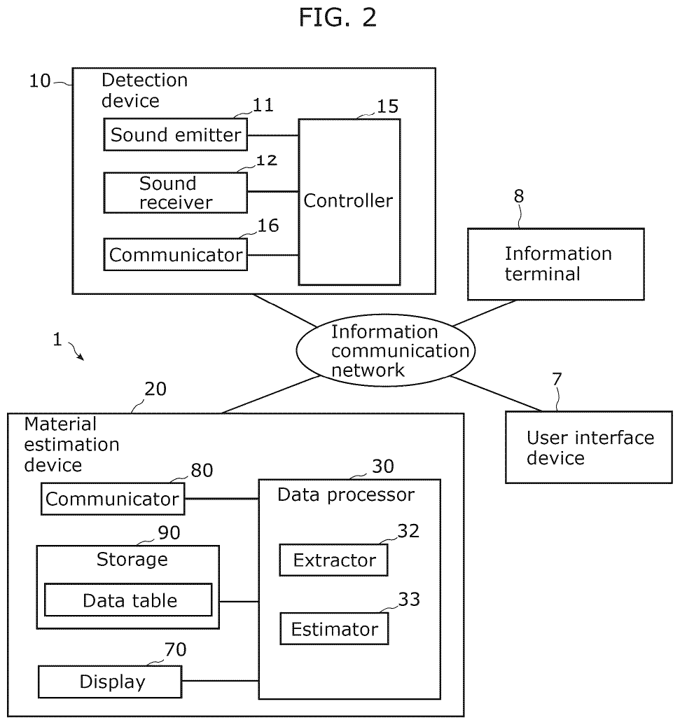

An overall configuration of a material estimation system according to Embodiment 1 will be described with reference to FIG. 1 and FIG. 2.

FIG. 1 is a drawing showing material estimation system 1 according to Embodiment 1.

Material estimation system 1 according to Embodiment 1 is a system that, with an object constituting real space S serving as estimation target Op, estimates the material of estimation target Op. Real space S is, for example, an indoor space of a house, an apartment, or the like. Real space S may also be an indoor space of an art museum, a museum, a department store, an event venue, or the like. Estimating the materials of objects constituting real space S and reflecting the result of the estimation into the data of a virtual space makes it possible to reproduce a more realistic space for, for example, a user virtually experiencing the indoor space.

FIG. 2 is a block diagram showing a functional configuration of material estimation system 1 as well as functional configurations of detection device 10, material estimation device 20, and so forth included in material estimation system 1.

Material estimation system 1 includes detection device 10, material estimation device 20, user interface device 7, and information terminal 8.

Detection device 10 is a device for detecting estimation target Op present in real space S. Detection device 10 is a portable device that can be carried around freely. Detection device 10 is disposed at a predetermined distance (e.g., 100 mm) from estimation target Op, such as a wall, a window, a ceiling, or a piece of furniture, and obtains information pertaining to estimation target Op. Detection device 10 obtains information pertaining to estimation target Op via the air present between detection device 10 and estimation target Op. In other words, detection device 10 obtains such information contactlessly. Detection device 10 is communicably connected to material estimation device 20 via an information communication network, and outputs information obtained by detection device 10 to material estimation device 20.

Material estimation device 20 is a device that estimates the material of estimation target Op based on the information received from detection device 10. Material estimation device 20 is installed outside real space S, such as in the building of the planning and production company producing the virtual space. Material estimation device 20 includes display 70, such as a monitor. Display 70 displays, for example but not limited to, material information indicating the material of estimation target Op estimated by material estimation device 20. Material estimation device 20 is communicably connected to detection device 10, user interface device 7, and information terminal 8 via the information communication network.

User interface device 7 is communicably connected to material estimation device 20 wirelessly via the information communication network. User interface device 7 displays various items of information received from material estimation device 20. User interface device 7 is, for example, a pair of virtual reality (VR) goggles to be worn by a person experiencing the virtual space or a smartphone or a tablet terminal held by the person experiencing the virtual space. In the following description, user interface device 7 is referred to as UI device 7.

Information terminal 8 is communicably connected to material estimation device 20 wirelessly via the information communication network. Information terminal 8 is a smartphone or a tablet terminal held by an information collector that collects on-site the information pertaining to estimation target Op in real space S. Information terminal 8 displays various items of information received from material estimation device 20.

### Configuration of Detection Device

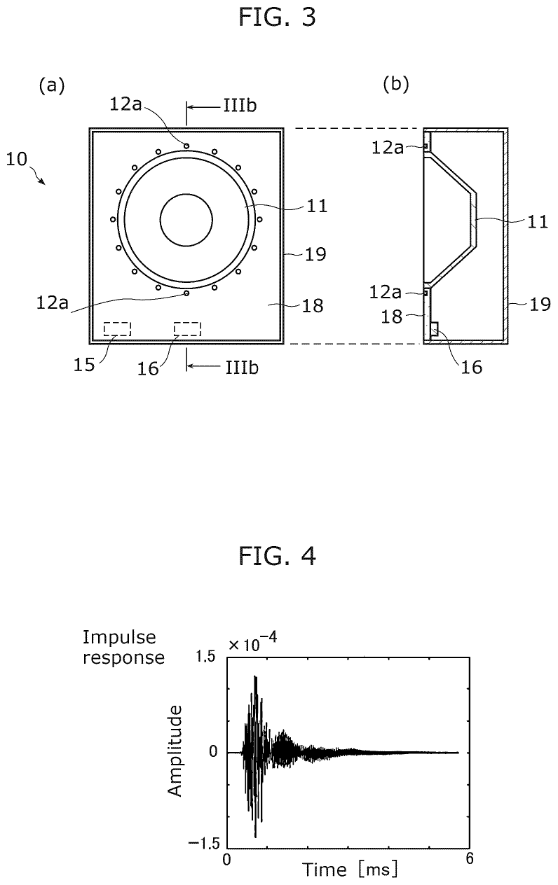

A configuration of detection device 10 will be described with reference to FIG. 3.

FIG. 3 is a drawing showing detection device 10 included in material estimation system 1. In FIG. 3, (a) shows a front view of detection device 10, and (b) shows a sectional view of detection device 10 cut along the IIIb-IIIb line marked in (a).

As shown in FIG. 3, detection device 10 includes sound emitter 11, sound receiver 12, controller 15, and communicator 16. Detection device 10 further includes printed circuit board 18, housing 19, and a battery (not shown). Sound emitter 11, sound receiver 12, controller 15, and communicator 16 are mounted on printed circuit board 18. Printed circuit board 18 is attached to the opening of housing 19, which has a box-like shape.

Communicator 16 is a communication module that is communicably connected to material estimation device 20 via the information communication network. Communicator 16 is connected to the information communication network wirelessly.

Sound emitter 11 is an ultrasonic wave emitter that emits an emission sound in the ultrasonic frequency range. Sound emitter 11 is, for example, a speaker and has a circular shape as viewed from the front. Sound emitter 11, in accordance with a command from controller 15, outputs an emission sound of a chirp waveform with, for example, a frequency of higher than or equal to 20 kHz and lower than or equal to 96 KHz. The emission sound emitted from sound emitter 11 is reflected by estimation target Op, and the resulting reflected sound is collected by sound receiver 12.

Sound receiver 12 is a receiver that obtains a reflected sound reflected by estimation target Op. Sound receiver 12 is constituted by two or more microphones 12a disposed on printed circuit board 18. In the present example, 16 micro electro mechanical system (MEMS) microphones are disposed at equal angular intervals around sound emitter 11.

Controller 15 is a processor that controls sound emitter 11, sound receiver 12, and communicator 16. Controller 15 outputs, to material estimation device 20 via communicator 16, information pertaining to a sound emission signal for emitting an emission sound from sound emitter 11 as well as information pertaining to a received sound signal that is based on a reflected sound obtained by sound receiver 12.

### Configuration of Material Estimation Device

A configuration of material estimation device 20 will be described with reference to FIG. 2 and FIG. 4 to FIG. 7.

Material estimation device 20 shown in FIG. 2 includes data processor 30, display 70, communicator 80, and storage 90.

Display 70 is a monitor that displays various items of information processed by data processor 30.

Communicator 80 is a communication module and is connected to detection device 10, UI device 7, and information terminal 8 via the information communication network. Communicator 80 obtains information output from detection device 10, and outputs the obtained information to data processor 30. Furthermore, communicator 80 outputs information generated by data processor 30 to UI device 7 and information terminal 8.

Storage 90 has stored therein a program for data processor 30 to perform data processing. Furthermore, storage 90 has stored therein in advance information pertaining to feature values of a plurality of materials. Storage 90 may further have stored therein the layout information of real space S, such as the floor plan of the room.

Data processor 30 is constituted by a computer that includes a processor and so forth. Each of the constituent elements of material estimation device 20, described later, may, for example, be realized by a software function implemented as the processor executes the program stored in storage 90.

Data processor 30 includes extractor 32 and estimator 33. Extractor 32 extracts an acoustic feature of estimation target Op. Estimator 33 estimates the material of estimation target Op. An acoustic feature of estimation target Op is one example of acoustic information indicating information characteristic to the sound from estimation target Op.

Extractor 32 obtains, via communicator 80, information pertaining to a sound emission signal output from detection device 10 as well as information pertaining to a received sound signal output from detection device 10. It is to be noted that in a case in which the information pertaining to a sound emission signal is held in material estimation device 20 in advance, detection device 10 may output only the information pertaining to a received sound signal, and extractor 32 may obtain only the information pertaining to the received sound signal.

Extractor 32 according to the present embodiment extracts a variety of acoustic features of estimation target Op, and examples of such acoustic features include reverberation time Tp of an impulse response and frequency characteristic Fp of a received sound signal.

Reverberation time Tp of an impulse response extracted by extractor 32 will be described first.

FIG. 4 is a drawing showing one example of an impulse response obtained from a reflected sound or the like reflected by estimation target Op.

In FIG. 4, the horizontal axis represents the time, and the vertical axis represents the amplitude. The signal waveform of the impulse response shown in FIG. 4 is derived through the following process.

In order to obtain a signal of a frequency in the ultrasonic frequency range, extractor 32 removes, from a received sound signal, any signals in the unwanted frequency range with the use of a high pass filter. A signal in the unwanted frequency range is a signal in the audio frequency range.

Then, extractor 32 calculates transfer function H(ω) through Equation 1 below, in which X(ω) is the Fourier transform of sound emission signal x(t) and Y(ω) is the Fourier transform of received sound signal y(t) mentioned above. Then, extractor 32 derives the impulse response by applying the inverse Fourier transform to transfer function H(ω).

$$H ( ω ) = Y ( ω ) / X ( ω ) \qquad Equation 1$$

Then, based on the signal waveform of the impulse response, extractor 32 derives reverberation time Tp of the impulse response. Reverberation time Tp is the length of time from when the sound source stops emitting a sound to when the reverberation sound is attenuated by 60 dB, and is derived from reverberation curve C illustrated below.

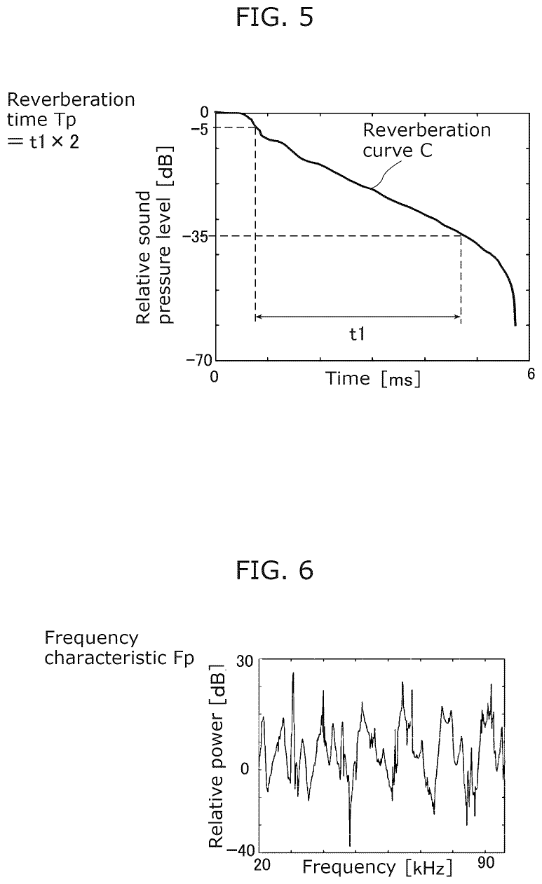

FIG. 5 is a drawing showing of reverberation curve C of the impulse response.

In FIG. 5, the horizontal axis represents the time, and the vertical axis represents the relative sound pressure level (the unit is in dB). Reverberation curve C shown in FIG. 5 is derived by applying the Schroeder integral (an inverse square integral) to the impulse response. According to the present embodiment, reverberation time Tp is derived by doubling time t1 that it takes for the relative sound pressure level of reverberation curve C to fall from −5 dB to −35 dB, that is, by doubling the length of time that it takes for the relative sound pressure level of reverberation curve C to be attenuated by 30 dB.

In this manner, extractor 32, based on a reflected sound, extracts an acoustic feature of estimation target Op, including information pertaining to reverberation time Tp of an impulse response.

Frequency characteristic Fp of a received sound signal extracted by extractor 32 will be described next.

FIG. 6 is a diagram showing one example of frequency characteristic Fp of a received sound signal that is based on a reflected sound.

In FIG. 6, the horizontal axis represents the frequency, and the vertical axis represents the relative power (the unit is in dB). FIG. 6 shows frequency characteristic Fp obtained when estimation target Op is made of wood. Frequency characteristic Fp is derived through a transfer function that is obtained with the denominator served by a signal obtained by applying the Fourier transform to a sound emission signal and with the numerator served by a signal obtained by applying the Fourier transform to a received sound signal.

It is to be noted that FIG. 6 shows pure frequency characteristic Fp of estimation target Op that does not include the frequency characteristics of materials other than estimation target Op. Pure frequency characteristic Fp of estimation target Op is derived by obtaining in advance the frequency characteristics of an estimation target made of a sound absorbing material as reference data and by removing the reference data from the data of the received sound signal. To be more specific, a transfer function held when an estimation target is a sound absorbing material is obtained in advance as transfer function Hr of reference data, transfer function Hm of a received sound signal is normalized by transfer function Hr of the reference data, and thus frequency characteristic Fp is obtained.

In this manner, extractor 32, based on a reflected sound, extracts an feature of estimation target Op, including the information pertaining to frequency characteristic Fp. The information pertaining to these feature values obtained by extractor 32 is output to estimator 33.

Estimator 33 estimates the material of estimation target Op based on the acoustic features of estimation target Op received from extractor 32.

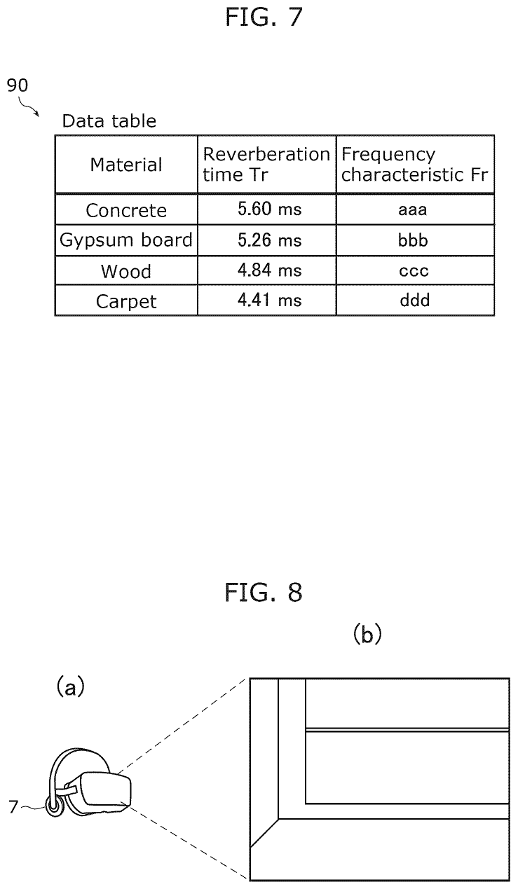

FIG. 7 is a drawing showing one example of feature values of a plurality of materials stored in advance in material estimation system 1.

FIG. 7 shows, as examples of the plurality of materials, concrete, a gypsum board, wood, and carpet. Furthermore, FIG. 7 shows, as examples of the feature values of the plurality of materials, reverberation times Tr of impulse responses of the respective materials and frequency characteristics Fr of the respective materials.

The data of the feature values of a plurality of materials are obtained in advance and stored in storage 90 in the form of a data table. Herein, although FIG. 7 shows frequency characteristics Fr in the form of character string data, in reality, frequency characteristics Fr are stored in the form of vector data representing their frequency characteristic curves.

Estimator 33 compares the acoustic feature of estimation target Op with the feature values of the plurality of materials stored in advance, and estimates that the material, among the plurality of materials, that has an acoustic feature close to the acoustic feature of estimation target Op is the material of estimation target Op.

For example, estimator 33 estimates that the material, among the plurality of materials, that has a time difference between reverberation time Tp and reverberation time Tr within a predetermined time range is the material of estimation target Op. Alternatively, estimator 33 may estimate that the material, among the plurality of materials, that has reverberation time Tr closest to reverberation time Tp of estimation target Op is the material of estimation target Op.

For example, estimator 33 estimates that the material, among the plurality of materials, that has a difference between frequency characteristic Fp and frequency characteristic Fr within a predetermined range is the material of estimation target Op. Alternatively, estimator 33 may estimate that the material, among the plurality of materials, that has frequency characteristic Fr closest to frequency characteristic Fp of estimation target Op is the material of estimation target Op.

Whether frequency characteristic Fr is close to frequency characteristic Fp is determined based on the degree of similarity between the vector representing frequency characteristic Fp of estimation target Op and the vector representing frequency characteristic Fr stored in storage 90. For the degree of similarity, the cosine similarity, for example, is used. Estimator 33 may estimate that the material, among the plurality of materials, that has frequency characteristic Fr satisfying the predetermined range of degrees of similarity is the material of estimation target Op.

Furthermore, estimator 33 may comprehensively evaluate a plurality of feature values, such as reverberation time Tp and frequency characteristic Fp, and may estimate the material of estimation target Op. Estimator 33 may estimate the material of estimation target Op by weighting each of reverberation time Tp and frequency characteristic Fp.

Data processor 30 causes display 70 to display material information pertaining to the material of estimation target Op. Furthermore, data processor 30 reflects the material information of estimation target Op into the data of the virtual space. Data processor 30 further outputs the data of the virtual space into which the material information has been reflected to UI device 7 and information terminal 8 via communicator 80.

### Display Examples of Estimation Result

Some examples of how an estimation result estimated by material estimation device 20 is displayed will be described with reference to FIG. 8 to FIG. 11.

FIG. 8 shows one example of a screen displayed on UI device 7.

UI device 7 is, for example, a pair of VR goggles, a smartphone, or a tablet terminal worn or held by a person experiencing the virtual space. Here, (a) of FIG. 8 shows a pair of VR goggles with a headphone, and (b) of FIG. 8 shows an image displayed in the pair of VR goggles. These drawings show an example in which a person experiences the virtual space having material information reflected therein through the pair of VR goggles. The user wearing the pair of VR goggles can experience in the virtual space reverberating sounds simulating real space S.

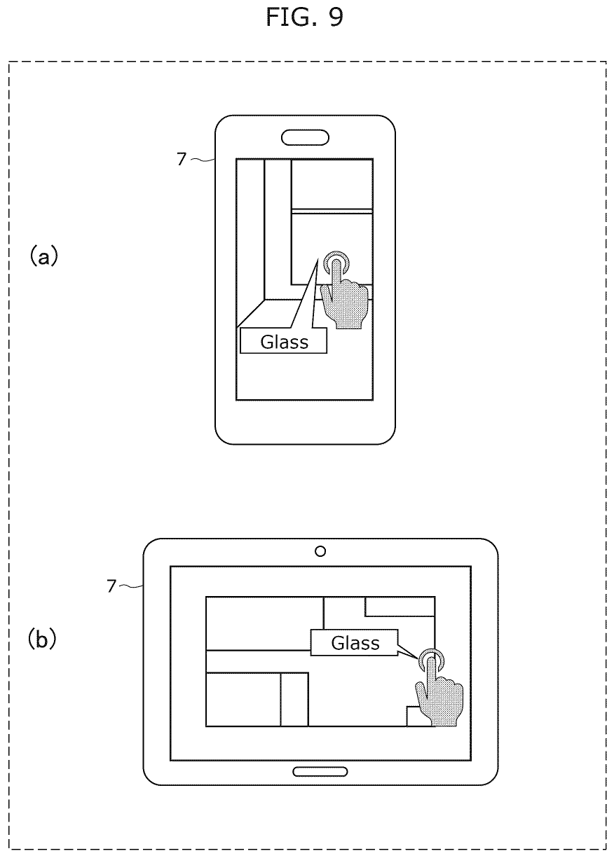

FIG. 9 shows another example of a screen displayed on UI device 7.

In (a) of FIG. 9, a virtual image that has material information reflected therein is displayed on the screen of a smartphone. As shown in (a) of FIG. 9, in response to the user touching a predetermined spot on the screen, the screen displays the material of the object located in the spot where the user has touched.

In (b) of FIG. 9, a floor plan that has material information reflected therein is displayed on the screen of a tablet terminal. As shown in (b) of FIG. 9, in response to the user touching a predetermined spot on the screen, the screen displays the material of the object located in the spot where the user has touched.

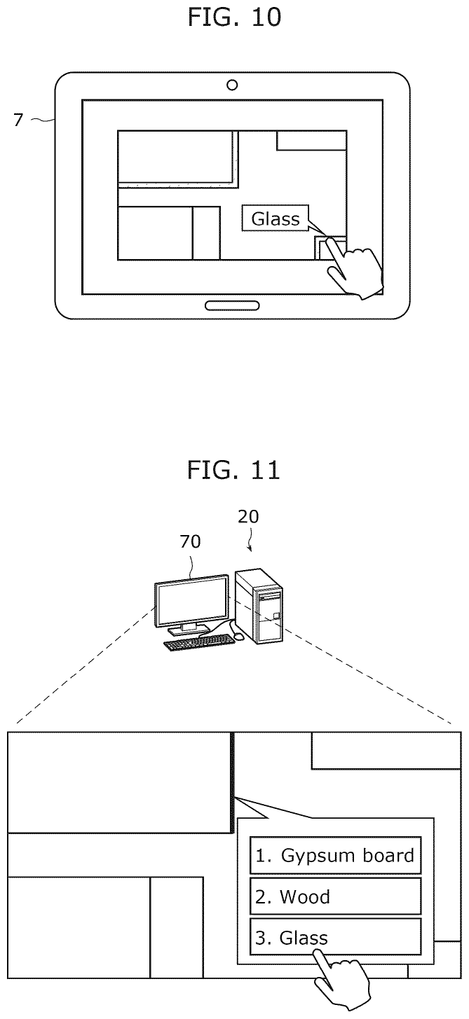

FIG. 10 shows yet another example of a screen displayed on UI device 7.

In FIG. 10, a virtual image that has material information reflected therein is displayed on the screen of a tablet terminal. As shown in FIG. 10, in response to the user touching a predetermined spot on the screen, the screen displays the objects made of the same material as the object located in the spot where the user has touched in the same color (with the hatching dots in the example shown in FIG. 10).

FIG. 11 shows one example of a screen displayed on material estimation device 20.

Material estimation device 20 shown in FIG. 11 is a computer held, for example, by a planning and production company that produces a virtual space. In FIG. 11, display 70 displays in order of similarity the materials having acoustic features close to the acoustic feature of estimation target Op. Material estimation device 20 may determine the material of estimation target Op by receiving an input selecting a material from the materials displayed on display 70.

In this manner, material estimation system 1 includes sound emitter 11 that emits an emission sound toward estimation target Op of which the material is to be estimated; sound receiver 12 that obtains a reflected sound of the emission sound reflected by estimation target Op; extractor 32 that, based on the reflected sound, extracts an acoustic feature of estimation target Op, the acoustic feature including information pertaining to reverberation time Tp of an impulse response; and estimator 33 that estimates the material of estimation target Op based on the acoustic feature of estimation target Op. This configuration makes it possible to estimate the material of estimation target Op based on the information pertaining to the sound from estimation target Op.

### Material Estimation Method

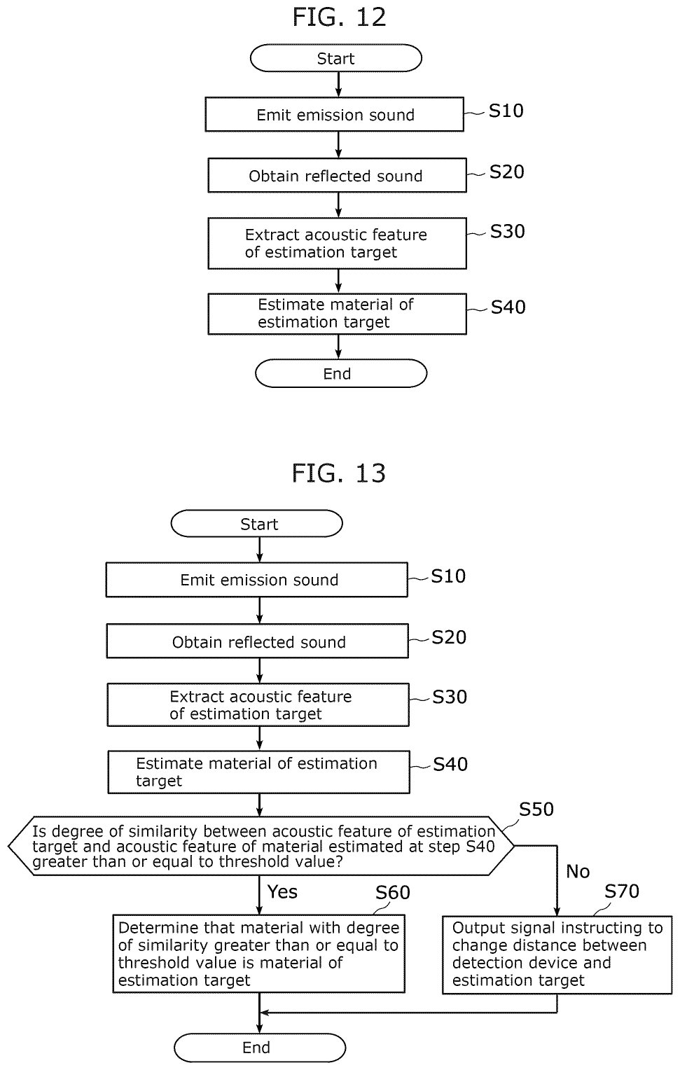

A material estimation method of estimating the material of estimation target Op will be described with reference to FIG. 12.

FIG. 12 is a flowchart showing a material estimation method according to Embodiment 1.

The material estimation method according to Embodiment 1 includes step S10 of emitting an emission sound, step S20 of obtaining a reflected sound, step S30 of extracting an acoustic feature of estimation target Op, and step S40 of estimating the material of estimation target Op.

At step S10, an emission sound of an ultrasonic wave is emitted from sound emitter 11 toward estimation target Op.

At step S20, based on the emission sound of an ultrasonic wave, a reflected sound reflected by estimation target Op is obtained by sound receiver 12.

At step S30, based on the reflected sound obtained at step S20, a acoustic feature of estimation target Op is extracted.

The acoustic feature of estimation target Op includes information pertaining to reverberation time Tp of an impulse response. The impulse response is derived by applying the inverse Fourier transform to a transfer function that is obtained with the denominator served by a signal obtained by applying the Fourier transform to a sound emission signal for emitting the emission sound and with the numerator served by a signal obtained by applying the Fourier transform to a received sound signal that is based on the reflected sound. Reverberation time Tp is the length of time that it takes for the relative sound pressure level of reverberation curve C obtained by applying the Schroeder integral to the impulse response to be attenuated by 60 dB.

Furthermore, the acoustic feature of estimation target Op includes frequency characteristic Fp of the received sound signal that is based on the reflected sound. Frequency characteristic Fp of the received sound signal is derived through a transfer function that is obtained with the denominator served by a signal obtained by applying the Fourier transform to the sound emission signal for emitting the emission sound and with the numerator served by a signal obtained by applying the Fourier transform to the received sound signal.

At step S40, based on the acoustic feature of estimation target Op estimated at step S30, the material of estimation target Op is estimated. Material estimation device 20 compares the acoustic feature of estimation target Op with the feature values of a plurality of materials stored in advance, and estimates that the material, among the plurality of materials, that has an acoustic feature close to the acoustic feature of estimation target Op is the material of estimation target Op.

For example, material estimation device 20 may estimate that the material, among the plurality of materials, that has reverberation time Tr closest to reverberation time Tp of estimation target Op is the material of estimation target Op. Alternatively, material estimation device 20 may estimate that the material, among the plurality of materials, that has frequency characteristic Fr closest to frequency characteristic Fp of estimation target Op is the material of estimation target Op. Furthermore, estimator 33 may comprehensively evaluate a plurality of feature values, such as reverberation time Tp and frequency characteristic Fp, and may estimate the material of estimation target Op. The material information pertaining to the material of estimation target Op is reflected in the data of the virtual space.

In this manner, the material estimation method includes emitting an emission sound toward estimation target Op of which the material is to be estimated; obtaining a reflected sound of the emission sound reflected by estimation target Op; extracting an acoustic feature of estimation target Op based on the reflected sound, the acoustic feature including information pertaining to reverberation time Tp of an impulse response; and estimating the material of estimation target Op based on the acoustic feature of estimation target Op. This method makes it possible to estimate the material of estimation target Op based on the information pertaining to the sound from estimation target Op.

### Variation 1 of Embodiment 1

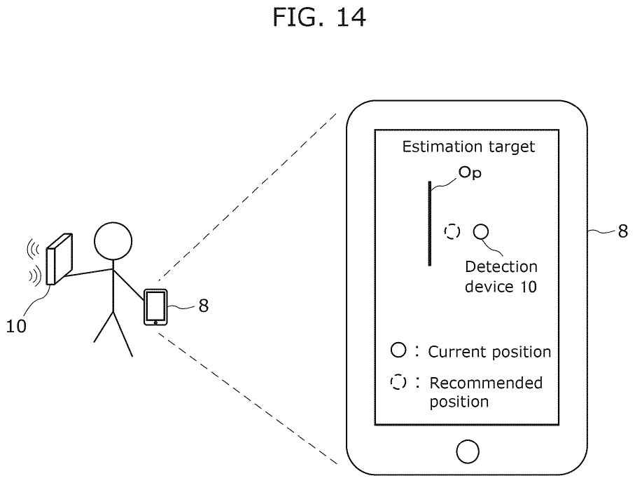

A material estimation method according to Variation 1 of Embodiment 1 will be described with reference to FIG. 13 and FIG. 14. In the example described according to Variation 1, the degree of similarity between an acoustic feature of estimation target Op and a feature value stored in storage 90 is obtained, and the accuracy of estimating the material will be increased.

FIG. 13 is a flowchart showing a material estimation method according to Variation 1 of Embodiment 1.

The material estimation method according to Variation 1 includes, in addition to step S10 to step S40 shown in FIG. 12, step S50 to step S70.

At step S50, it is determined whether the degree of similarity between the two feature values, namely, the feature value of the sound from estimation target Op and the feature value of the material estimated at step S40 is higher than or equal to a threshold value set in advance. The degree of similarity between the two feature values is derived with the use of a technique such as the cosine similarity. For example, when the threshold value set in advance is 0.6, the degree of similarity is determined to be high if the cosine similarity is higher than or equal to 0.6 and lower than or equal to 1, or the degree of similarity is determined to be low if the cosine similarity is higher than or equal to 0 and lower than 0.6.

If the degree of similarity between the two feature values is higher than or equal to the threshold value set in advance (Yes at S50), material estimation device 20 determines that the material with the degree of similarity higher than or equal to the threshold value is the material of estimation target Op. Information pertaining to the determined material of estimation target Op is presented on, for example, display 70 (step S60).

Meanwhile, if the degree of similarity between the two feature values is lower than the threshold value set in advance (No at S50), material estimation device 20 outputs a signal instructing to change the distance between estimation target Op and detection device 10, the device that obtains a reflected sound (step S70).

FIG. 14 is a drawing showing one example of a screen displayed on information terminal 8 according to Variation 1. Information terminal 8 is a smartphone or a tablet terminal held by an information collector that collects on-site the information pertaining to estimation target Op.

FIG. 14 schematically shows the positional relationship between detection device 10 and a wall that serves as estimation target Op. When the degree of similarity between the two feature values is lower than the threshold value set in advance (No at S50), material estimation device 20 determines that the position of detection device 10 relative to estimation target Op is not appropriate, and causes information terminal 8 to display the position of detection device 10 recommended in detecting estimation target Op (this position is referred to as a recommended position). The person holding information terminal 8, that is, the information collector can thus adjust the position of detection device 10 while looking at the display on information terminal 8.

Herein, when detection device 10 is too far from estimation target Op, material estimation device 20 may cause information terminal 8 to display a screen instructing, for example, the information collector to bring detection device 10 closer to estimation target Op. Meanwhile, when detection device 10 is too close to estimation target Op, material estimation device 20 may cause information terminal 8 to display a screen instructing, for example, the information collector to move detection device 10 away from estimation target Op. The distance between detection device 10 and estimation target Op can be obtained based on the difference between the time at which an estimation sound is emitted and the time at which the reflected sound is obtained.

In this manner, when the degree of similarity between the two feature values is higher than or equal to the threshold value set in advance, the material that is stored in storage 90 and estimated at step S40 is determined to be the material of estimation target Op, and thus the accuracy of estimating the material can be increased. Meanwhile, when the degree of similarity between the two feature values is lower than the threshold value set in advance, a signal instructing to change the distance between detection device 10 and estimation target Op is output, and thus the accuracy of estimating the material can be increased.

### Variation 2 of Embodiment 1

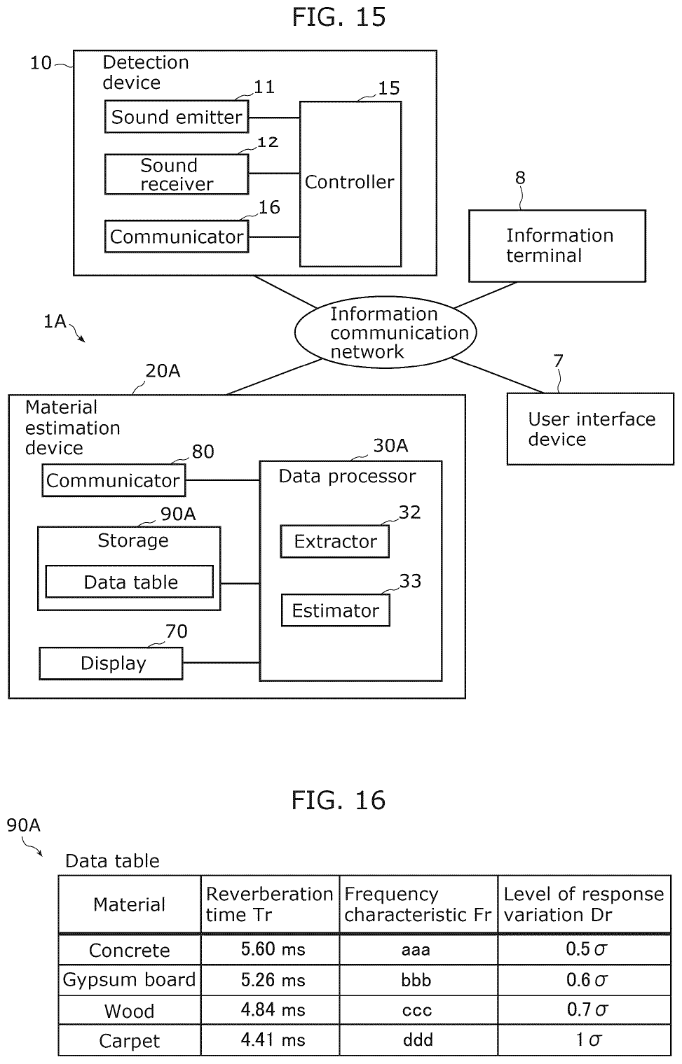

Material estimation system 1A according to Variation 2 of Embodiment 1 will be described with reference to FIG. 15. In the example described according to Variation 2, the material of estimation target Op is estimated with information of a sound related to the unevenness of the surface of estimation target Op used as a feature value.

FIG. 15 is a block diagram showing a functional configuration of material estimation system 1A according to Variation 2 of Embodiment 1.

Material estimation system 1A according to Variation 2 includes detection device 10, material estimation device 20A, UI device 7, and information terminal 8. Detection device 10, UI device 7, and information terminal 8 according to Variation 2 are similar to those according to Embodiment 1.

Material estimation device 20A according to Variation 2 includes data processor 30A, display 70, communicator 80, and storage 90A. Display 70 and communicator 80 are similar to those according to Embodiment 1.

Storage 90A has stored therein a program for data processor 30A to perform data processing. Furthermore, storage 90A has stored therein in advance information pertaining to feature values of a plurality of materials.

Data processor 30A includes extractor 32 and estimator 33. Extractor 32 extracts an acoustic feature of estimation target Op. Estimator 33 estimates the material of estimation target Op.

Extractor 32 obtains, via communicator 80, information pertaining to a sound emission signal output from detection device 10 as well as information pertaining to a received sound signal output from detection device 10.

Extractor 32 according to Variation 2 extracts a variety of acoustic features of estimation target Op, and examples of such acoustic features include, in addition to reverberation time Tp of an impulse response and frequency characteristic Fp of a received sound signal, information of the sound related to the unevenness of the surface of estimation target Op.

For example, extractor 32 derives an impulse response for each of the received sound signals based on the respective received sound signals received by the plurality of microphones 12a, and obtains the cross correlation coefficients of the plurality of impulse responses. Then, extractor 32 outputs, to estimator 33, information pertaining to the level of variation in the cross correlation coefficients of the plurality of impulse responses as one example of a feature value. In the following description, the level of variation in the cross correlation coefficients of the plurality of impulse responses is referred to as level of response variation Dp.

Level of response variation Dp is information about a sound related to the unevenness of the surface of estimation target Op. Level of response variation Dp is expressed by the variation or the standard deviation. For example, high level of response variation Dp indicates that estimation target Op has a rough surface, and low level of response variation Dp indicates that estimation target Op has a smooth surface. According to Variation 2, the material of estimation target Op is estimated, with the use of the relationship that different materials constituting estimation target Op yield different patterns of surface unevenness. In other words, estimator 33 estimates the material of estimation target Op based on level of response variation Dp obtained by extractor 32.

FIG. 16 is a drawing showing one example of feature values of a plurality of materials stored in advance in material estimation device 20A according to Variation 2.

FIG. 16 shows, as examples of the plurality of materials, concrete, a gypsum board, wood, and carpet. FIG. 16 also shows, as one example of the feature values of the plurality of materials, level of response variation Dr of each of the materials, in addition to reverberation times Tr of the impulse responses of the respective materials and frequency characteristics Fr of the respective materials. The data of this level of response variation Dr is obtained in advance and stored in storage 90A in the form of a data table.

Estimator 33 estimates that the material, among the plurality of materials, that has a difference between level of response variation Dp and level of response variation Dr within a predetermined range is the material of estimation target Op. Alternatively, estimator 33 may estimate that the material, among the plurality of materials, that has level of response variation Dr closest to level of response variation Dp of estimation target Op is the material of estimation target Op. Furthermore, estimator 33 may comprehensively evaluate a plurality of feature values, such as reverberation time Tp, frequency characteristic Fp, and level of response variation Dp, and may estimate the material of estimation target Op.

In this manner, information about the sound related to the unevenness of the surface of estimation target Op can be added to the acoustic features of estimation target Op, and thus the accuracy in estimating the material of estimation target Op can be increased.

### Variation 3 of Embodiment 1

Material estimation system 1B according to Variation 3 of Embodiment 1 will be described. In the example described according to Variation 3, the material of estimation target Op is estimated with the use of learning model M1.

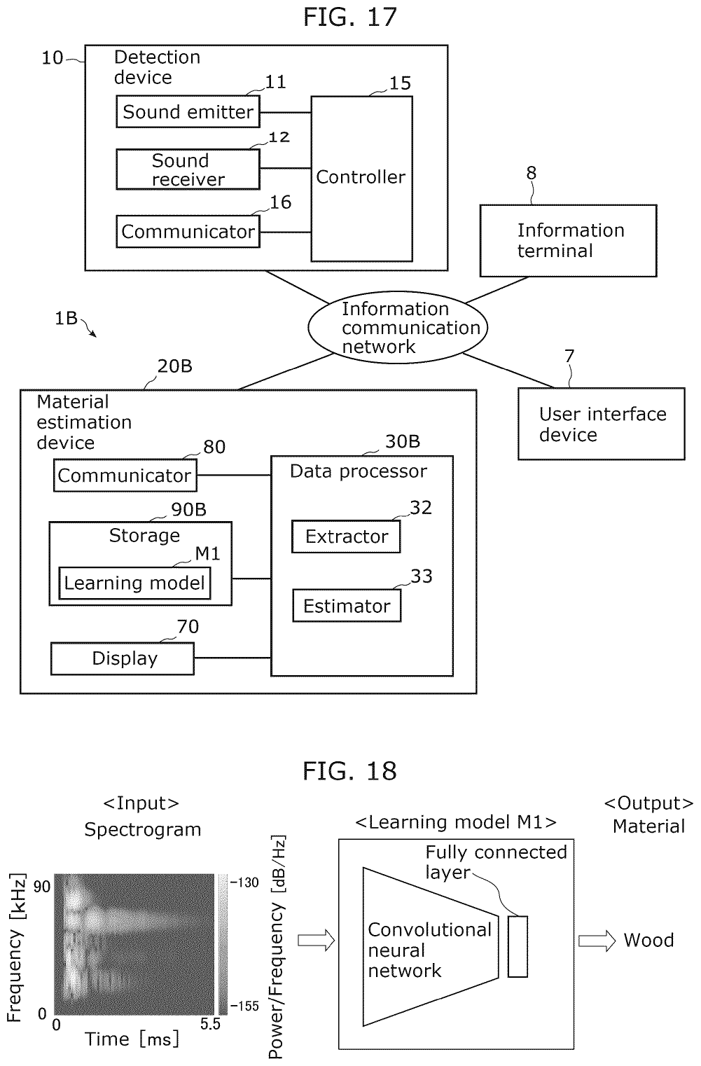

FIG. 17 is a drawing showing material estimation system 1B according to Variation 3 of Embodiment 1.

Material estimation system 1B according to Variation 3 includes detection device 10, material estimation device 20B, UI device 7, and information terminal 8. Detection device 10, UI device 7, and information terminal 8 according to Variation 3 are similar to those according to Embodiment 1.

Material estimation device 20B according to Variation 3 includes data processor 30B, display 70, communicator 80, and storage 90B. Display 70 and communicator 80 are similar to those according to Embodiment 1.

Storage 90B has stored therein a program for data processor 30B to perform data processing. Furthermore, storage 90B has stored therein in advance learning model M1 to be used in estimating the material of estimation target Op.

Data processor 30B includes extractor 32 and estimator 33. Extractor 32 extracts an acoustic feature of estimation target Op. Estimator 33 estimates the material of estimation target Op.

Extractor 32 obtains, via communicator 80, information pertaining to a sound emission signal output from detection device 10 as well as information pertaining to a received sound signal output from detection device 10. Furthermore, extractor 32 derives an impulse response based on the received sound signal and obtains a spectrogram by applying the Fourier transform to the derived impulse response. The spectrogram is one example of the feature values indicating the features pertaining to the sound from estimation target Op.

Estimator 33 estimates the material of estimation target Op with the use of learning model M1 stored in storage 90B.

FIG. 18 is a drawing showing learning model M1 and so forth used in material estimation device 20B according to Variation 3. FIG. 18 also shows the mode of input and the mode of output of learning model M1.

The spectrogram shown in FIG. 18 is image data in which the horizontal axis represents the time and the vertical axis represents the frequency. The example shown in FIG. 18 is data obtained when estimation target Op is made of wood. The gradation of the color in the image represents the power/frequency of the sound (the unit is in dB/Hz), and, in this example, a lighter color indicates a higher sound power. FIG. 18 further shows information pertaining to the reverberation time in which the sound power is attenuated.

Learning model M1 used in estimator 33 is a model equipped with a convolutional neural network and a fully connected layer. The convolutional neural network is constituted by a plurality of convolution layers and an activation function.

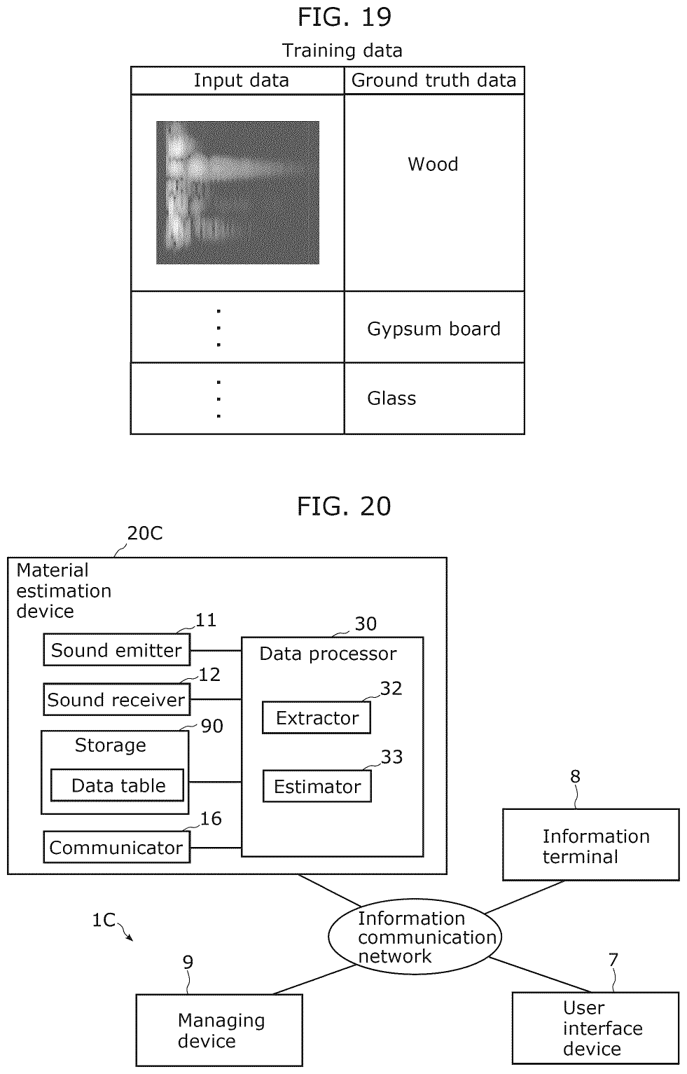

FIG. 19 is a drawing showing training data to be used in training learning model M1.

FIG. 19 shows training data in which the spectrogram including information pertaining to the reverberation times is used as input and information pertaining to the materials is used as output. Learning model M1 is a model trained by machine learning with the use of the training data served by the information pertaining to the spectrogram and the materials. Learning model M1 generated in advance through machine learning is stored in storage 90B.

Estimator 33 inputs the spectrogram obtained by extractor 32 into learning model M1, and thus outputs the material of estimation target Op. This material estimation system 1B makes it possible to estimate the material of estimation target Op based on the spectrogram pertaining to a sound from estimation target Op.

### Embodiment 2

Material estimation system 1C according to Embodiment 2 will be described. In the example described according to Embodiment 2, material estimation device 20C is equipped with the function of detection device 10 illustrated according to Embodiment 1.

FIG. 20 is a block diagram showing a functional configuration of material estimation system 1C according to Embodiment 2.

As shown in FIG. 20, material estimation system 1C includes material estimation device 20C, UI device 7, information terminal 8, and managing device 9.

Material estimation device 20C includes sound emitter 11, sound receiver 12, communicator 16, data processor 30, and storage 90. Material estimation device 20C emits an emission sound by sound emitter 11 and obtains a reflected sound reflected by estimation target Op by sound receiver 12. Data processor 30 receives a received sound signal output from sound receiver 12 and, by performing data processing similar to the data processing according to Embodiment 1, estimates the material of estimation target Op. Material information estimated by material estimation device 20C is output to managing device 9.

Managing device 9 is a device that processes and manages data based on information output from material estimation device 20C. Managing device 9 is communicably connected to material estimation device 20C, UI device 7, and information terminal 8 via the information communication network. Managing device 9 is installed outside real space S, such as in the building of the planning and production company producing the virtual space. Managing device 9 includes a display, such as a monitor, and the display displays, for example but not limited to, the material information estimated by material estimation device 20C. Furthermore, managing device 9 reflects the material information of estimation target Op into the data of the virtual space, and outputs the data of the virtual space into which the material information has been reflected to UI device 7 and information terminal 8.

Material estimation system 1C according to Embodiment 2 is also capable of estimating the material of estimation target Op based on information pertaining to a sound from estimation target Op.

### Other Embodiments

Thus far, the material estimation method and so forth according to the embodiments of the present disclosure have been described, but these embodiments do not limit the present disclosure. Unless departing from the spirit of the present disclosure, an embodiment obtained by making various modifications that a person skilled in the art can conceive of to the foregoing embodiments or an embodiment obtained by combining constituent elements according to different embodiments may also be encompassed within the scope of the one or more aspects of the present disclosure.

For example, while extractor 32 and estimator 33 of the material estimation device according to Embodiment 1 are separate constituent elements, the function of extractor 32 and the function of estimator 33 may be realized by a single constituent element.

For example, while sound emitter 11 and sound receiver 12 are separate constituent elements in the example described according to Embodiment 1, this is not a limiting example, and sound emitter 11 and sound receiver 12 may be implemented by an integrated ultrasonic wave sensor.

For example, while material estimation device 20 is constituted by hardware in the example described according to Embodiment 1, this is not a limiting example, and the function of the material estimation device may be realized through cloud computing.

Furthermore, learning model M1 used according to Variation 3 of Embodiment 1 may be a model trained by machine learning based on information pertaining to the signal waveforms of impulse responses and the materials. In this case, such a trained model outputs information indicating the material of estimation target Op in response to receiving an input of the signal waveform of an impulse response.

The constituent elements according to Embodiment 1 and Embodiment 2 may each be implemented through the execution of a software program suitable for the corresponding constituent element. The constituent elements may each be implemented as a program executing unit, such as a central processing unit (CPU) or a processor, reads out a software program recorded on a recording medium, such as a hard disk or a semiconductor memory, and executes the software program.

Meanwhile, the constituent elements may each be implemented by hardware. The constituent element may each be a circuit (or an integrated circuit). These circuits may be configured as a single circuit as a whole or may be configured as respectively separate circuits. Furthermore, these circuits may each be a general purpose circuit or a dedicated circuit.

Furthermore, general or specific aspects of the present disclosure may be implemented in the form of a system, a device, a method, an integrated circuit, a computer program, or a computer readable recording medium, such as a CD-ROM. Furthermore, the general or specific aspects may be implemented through a desired combination of a system, a device, a method, an integrated circuit, a computer program, and a recording medium.

For example, the present disclosure may be implemented in the form of a data processor according to the foregoing embodiments or may be implemented in the form of an information processing system according to the foregoing embodiments. Furthermore, the present disclosure may be implemented in the form of an information processing method that is executed by a computer, such as an information processing system according to the foregoing embodiments. The present disclosure may also be implemented in the form of a program that causes a computer to execute such an information processing method or may also be implemented in the form of a non-transitory computer readable recording medium having such a program recorded thereon.

### INDUSTRIAL APPLICABILITY

The material estimation method and so forth according to the present disclosure can be used widely for the purpose of estimating the material of an estimation target.

1. A material estimation method to be executed by a computer, the material estimation method comprising:
emitting an emission sound toward an estimation target of which a material is to be estimated;
obtaining a reflected sound of the emission sound reflected by the estimation target;
extracting an acoustic feature of the estimation target based on the reflected sound, the acoustic feature including information pertaining to a reverberation time of an impulse response; and
estimating the material of the estimation target based on the acoustic feature of the estimation target.

2. The material estimation method according to claim 1, wherein
the sound is an ultrasonic wave.

3. The material estimation method according to claim 1, wherein
the impulse response is derived by applying inverse Fourier transform to a transfer function in which a denominator is a signal obtained by applying Fourier transform to a sound emission signal for emitting the emission sound and a numerator is a signal obtained by applying Fourier transform to a received sound signal that is based on the reflected sound.

4. The material estimation method according to claim 1, wherein
the acoustic feature of the estimation target further includes a frequency characteristic of a received sound signal that is based on the reflected sound.

5. The material estimation method according to claim 4, wherein
the frequency characteristic is derived based on a transfer function in which a denominator is a signal obtained by applying Fourier transform to a sound emission signal for emitting the emission sound and a numerator is a signal obtained by applying Fourier transform to the received sound signal.

6. The material estimation method according to claim 1, wherein
the material of the estimation target is estimated by comparing the acoustic feature of the estimation target with acoustic features of materials stored.

7. The material estimation method according to claim 1, wherein
the acoustic feature of the estimation target includes a spectrogram that includes information pertaining to the reverberation time, and
the material of the estimation target is estimated by inputting the spectrogram to a learning model.

8. The material estimation method according to claim 7, wherein
the learning model is a model trained by machine learning with use of the spectrogram and information pertaining to the material.

9. The material estimation method according to claim 1, further comprising:
obtaining degrees of similarity between the acoustic feature of the estimation target and acoustic features of materials stored; and
determining, among the materials stored, a material having a degree of similarity higher than or equal to a predetermined value to be the material of the estimation target.

10. The material estimation method according to claim 1, further comprising:
obtaining degrees of similarity between the acoustic feature of the estimation target and acoustic features of materials stored; and
when the degrees of similarity are lower than a predetermined value, outputting a signal to change a distance between the estimation target and a device that obtains the reflected sound.

11. The material estimation method according to claim 1, wherein
the acoustic feature of the estimation target further includes information about the sound related to surface unevenness of the estimation target.

12. A material estimation system comprising:
a sound emitter that emits an emission sound toward an estimation target of which a material is to be estimated;
a sound receiver that obtains a reflected sound of the emission sound reflected by the estimation target;
an extractor that extracts an acoustic feature of the estimation target based on the reflected sound, the acoustic feature including information pertaining to a reverberation time of an impulse response; and
an estimator that estimates the material of the estimation target based on the acoustic feature of the estimation target.

13. A material estimation device comprising:
an extractor that, based on a reflected sound of an emission sound emitted toward an estimation target of which a material is to be estimated and reflected by the estimation target, extracts an acoustic feature of the estimation target, the acoustic feature including information pertaining to a reverberation time of an impulse response; and
an estimator that estimates the material of the estimation target based on the acoustic feature of the estimation target.

14. A non-transitory computer-readable recording medium having recorded thereon a program for causing a computer to execute the material estimation method according to claim 1.
